(19) United States
(12) Patent Application Publication
(10) Pub. No.: US 2008/0068295 A1
(43) Pub. Date: Mar. 20, 2008

(54) Compensation for Spatial Variation in Displayed Image in Scanning Beam Display Systems Using Light-Emitting Screens

(76) Inventor: Roger A. Hajjar, San Jose, CA (US)

Correspondence Address: FISH & RICHARDSON, PC, P.O. BOX 1022, MINNEAPOLIS, MN, 55440-1022, US

(21) Appl. No.: 11/858,094

(22) Filed: Sep. 19, 2007

Related U.S. Application Data
(60) Provisional application No. 60/846,017, filed on Sep. 19, 2006.

(51) Int. Cl. G09G 5/00

(52) U.S. Cl. 345/3.2

(57) ABSTRACT

Implementations of display systems and devices based on scanning light on a light-emitting screen where at least one excitation optical beam is used to excite one or more light-emitting materials on the screen which emits light to form images. The light-emitting materials may include fluorescent and phosphor materials. A control mechanism is described to reduce the spatial variation in screen brightness.

This application claims priority of U.S. Provisional Application No. 60/846,017 entitled “COMPENSATION FOR SPATIAL VARIATION IN DISPLAYED IMAGE IN SCANNING BEAM DISPLAY SYSTEMS USING FLUORESCENT SCREENS” and filed on Sep. 19, 2006, which is incorporated by reference as part of the specification of this application.

### BACKGROUND

This application relates to display systems that use screens with fluorescent materials to emit colored light under optical excitation, such as laser-based image and video displays and screen designs for such displays.

Image and video displays can be designed to directly produce light of different colors that carry color images and to project the color images on a screen, where the screen makes the color images visible to a viewer by reflection, diffusion or scattering of the received light and does not emit light. Examples of such displays include digital light processing (DLP) displays, liquid crystal on silicon (LCOS) displays, and grating light valve (GLV) displays. Some other image and video displays use a light-emitting screen that produces light of different colors to form color images. Examples of such display systems include cathode-ray tube (CRT) displays, plasma displays, liquid crystal displays (LCDs), light-emitting-diode (LED) displays (e.g., organic LED displays), and field-emission displays (FEDs).

### SUMMARY

The specification of this application describes, among others, implementations of display systems and devices based on scanning light on a light-emitting screen where at least one excitation optical beam is used to excite one or more light-emitting materials on the screen which emits light to form images. The light-emitting materials may include fluorescent and phosphor materials. In one example, a display screen described in this application includes a light-emitting layer comprising parallel and separated light-emitting stripes each absorbing excitation light at an excitation wavelength to emit visible light at a visible wavelength different from the excitation wavelength.

In one aspect, this application describes an implementation of a method for controlling a scanning beam display system. This implementation includes scanning a beam of excitation light modulated with optical pulses on a screen with a fluorescent layer to excite the fluorescent layer to emit visible fluorescent light which forms images; and adjusting optical power of the optical pulses in the beam of excitation light as the beam of excitation light moves from one screen position to another based on a spatial variation in pixel brightness of the screen to negate the spatial variation in pixel brightness of the screen.

In another aspect, an implementation of a scanning beam display system is described to include an optical module operable to produce a beam of excitation light having optical pulses that can carry image information; a beam scanning module to scan the beam of excitation light along a first direction and a second, perpendicular direction; and a screen comprising a light-emitting area having a plurality of parallel light-emitting stripes each along the first direction and spatially displaced from one another along the second direction. The stripes absorb the excitation light and emit visible light to produce images carried by the scanning beam of excitation light. A control unit is provided to adjust optical power of the optical pulses in the beam of excitation light as the beam of excitation light moves from one screen position to another based on a spatial variation in pixel brightness of the screen to negate the spatial variation in pixel brightness of the screen.

In yet another example, an implementation for a method for controlling a scanning beam display system is described to include scanning a beam of excitation light modulated with optical pulses on a screen with parallel light-emitting stripes in a beam scanning direction perpendicular to the light-emitting stripes to excite the light-emitting strips to emit visible light which forms images; modulating the beam of excitation light to carry a test image pattern which is displayed on the screen for calibrating the scanning beam display system; measuring brightness of each pixel of the screen when the test image pattern is displayed to collect measured pixel brightness of the screen to represent spatial variation in pixel brightness of the screen; and storing the measured pixel brightness of the screen for adjusting optical power of the optical pulses in the beam of excitation light, during a normal display of images on the screen, as the beam of excitation light moves from one screen position to another to negate the spatial variation in pixel brightness of the screen.

These and other examples and implementations are described in detail in the drawings, the detailed description, and the claims.

### BRIEF DESCRIPTION OF THE DRAWINGS

FIG. 1 shows an example scanning laser display system having a fluorescent screen made of laser-excitable fluorescent materials (e.g., phosphors) emitting colored lights under excitation of a scanning laser beam that carries the image information to be displayed.

FIGS. 2A and 2B show one example screen structure and the structure of color pixels on the screen in FIG. 1.

FIG. 3A shows an example implementation of the laser module in FIG. 1 having multiple lasers that direct multiple laser beams on the screen.

FIG. 3B shows an example implementation of a post-objective scanning beam display system.

FIG. 4 illustrates an example screen having a fluorescent stripe layer with fluorescent stripes for emitting red, green and blue colors under optical excitation of the scanning excitation light.

FIGS. 5A and 5B show two folded optical designs that direct the output scanning laser beams from the laser module 110 to the fluorescent screen 101 in rear projection configurations.

FIG. 6 shows one example for time division on each modulated laser beam 120 where each color pixel time is equally divided into three sequential time slots for the three color channels.

FIG. 7 shows one example for simultaneously scanning consecutive scan lines with multiple excitation laser beams.

FIG. 8 shows one example of a scanning display system using a servo feedback control and an on-screen optical sensing unit.

FIG. 9 shows one example of a fluorescent screen with on-screen optical servo detectors.

FIG. 10 shows one example of a scanning display system using a servo feedback control and an off-screen optical sensing unit.

FIGS. 11A and 11B show variations in optical transmission of a dichroic layer that reflects visible light and transmits excitation light.

FIG. 12 shows an example of a calibration process of for obtaining a pixel-by-pixel map of the screen brightness and an example of using the map to control the system in the normal operation

### DETAILED DESCRIPTION

This application describes scanning beam display systems that use screens with light-emitting materials such as phosphor or fluorescent materials to emit light under optical excitation to produce images, including laser video display systems. Various examples of screen designs with light-emitting materials are described. Screens with phosphor materials under excitation of one or more scanning excitation laser beams are described in detail and are used as specific implementation examples of optically excited light-emitting materials in various system and device examples in this application.

In one implementation, for example, three different color phosphors that are optically excitable by the laser beam to respectively produce light in red, green, and blue colors suitable for forming color images may be formed on the screen as pixel dots or repetitive red, green and blue phosphor stripes in parallel. Various examples described in this application use screens with parallel color phosphor stripes for emitting light in red, green, and blue to illustrate various features of the laser-based displays.

Phosphor materials are one type of fluorescent materials. Various described systems, devices and features in the examples that use phosphors as the fluorescent materials are applicable to displays with screens made of other optically excitable, light-emitting, non-phosphor fluorescent materials. For example, quantum dot materials emit light under proper optical excitation and thus can be used as the fluorescent materials for systems and devices in this application. More specifically, semiconductor compounds such as, among others, CdSe and PbS, can be fabricated in form of particles with a diameter on the order of the exciton Bohr radius of the compounds as quantum dot materials to emit light. To produce light of different colors, different quantum dot materials with different energy band gap structures may be used to emit different colors under the same excitation light. Some quantum dots are between 2 and 10 nanometers in size and include approximately tens of atoms such between 10 to 50 atoms. Quantum dots may be dispersed and mixed in various materials to form liquid solutions, powders, jelly-like matrix materials and solids (e.g., solid solutions). Quantum dot films or film stripes may be formed on a substrate as a screen for a system or device in this application. In one implementation, for example, three different quantum dot materials can be designed and engineered to be optically excited by the scanning laser beam as the optical pump to produce light in red, green, and blue colors suitable for forming color images. Such quantum dots may be formed on the screen as pixel dots arranged in parallel lines (e.g., repetitive sequential red pixel dot line, green pixel dot line and blue pixel dot line).

Examples of scanning beam display systems described here use at least one scanning laser beam to excite color light-emitting materials deposited on a screen to produce color images. The scanning laser beam is modulated to carry images in red, green and blue colors or in other visible colors and is controlled in such a way that the laser beam excites the color light-emitting materials in red, green and blue colors with images in red, green and blue colors, respectively. Hence, the scanning laser beam carries the images but does not directly produce the visible light seen by a viewer. Instead, the color light-emitting fluorescent materials on the screen absorb the energy of the scanning laser beam and emit visible light in red, green and blue or other colors to generate actual color images seen by the viewer.

Laser excitation of the fluorescent materials using one or more laser beams with energy sufficient to cause the fluorescent materials to emit light or to luminance is one of various forms of optical excitation. In other implementations, the optical excitation may be generated by a non-laser light source that is sufficiently energetic to excite the fluorescent materials used in the screen. Examples of non-laser excitation light sources include various light-emitting diodes (LEDs), light lamps and other light sources that produce light at a wavelength or a spectral band to excite a fluorescent material that converts the light of a higher energy into light of lower energy in the visible range. The excitation optical beam that excites a fluorescent material on the screen can be at a frequency or in a spectral range that is higher in frequency than the frequency of the emitted visible light by the fluorescent material. Accordingly, the excitation optical beam may be in the violet spectral range and the ultra violet (UV) spectral range, e.g., wavelengths under 420 nm. In the examples described below, UV light or a UV laser beam is used as an example of the excitation light for a phosphor material or other fluorescent material and may be light at other wavelength.

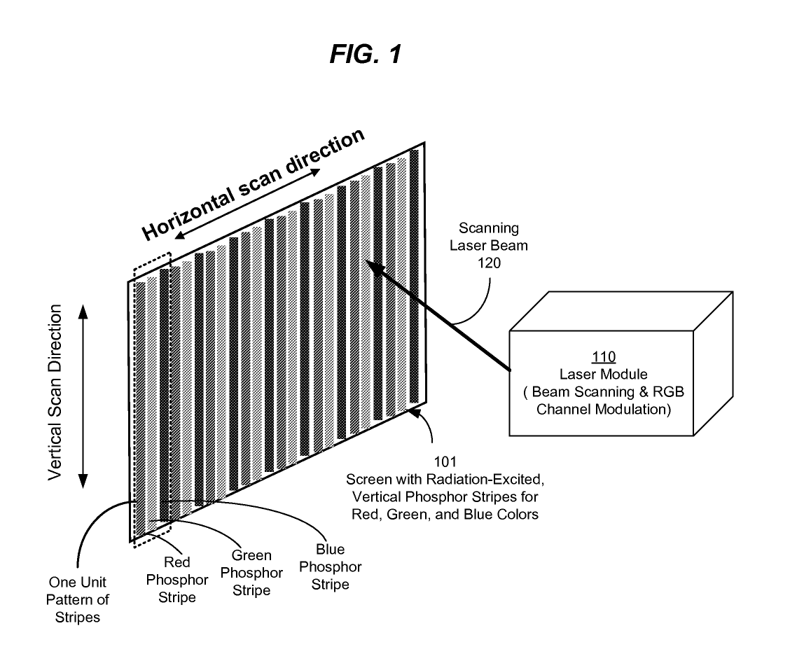

FIG. 1 illustrates an example of a laser-based display system using a screen having color phosphor stripes. Alternatively, color phosphor dots may also be used to define the image pixels on the screen. The system includes a laser module 110 to produce and project at least one scanning laser beam 120 onto a screen 101. The screen 101 has parallel color phosphor stripes in the vertical direction and two adjacent phosphor stripes are made of different phosphor materials that emit light in different colors. In the illustrated example, red phosphor absorbs the laser light to emit light in red, green phosphor absorbs the laser light to emit light in green and blue phosphor absorbs the laser light to emit light in blue. Adjacent three color phosphor stripes are in three different colors. One particular spatial color sequence of the stripes is shown in FIG. 1 as red, green and blue. Other color sequences may also be used. The laser beam 120 is at the wavelength within the optical absorption bandwidth of the color phosphors and is usually at a wavelength shorter than the visible blue and the green and red colors for the color images. As an example, the color phosphors may be phosphors that absorb UV light in the spectral range from about 380 nm to about 420 nm to produce desired red, green and blue light. The laser module 110 can include one or more lasers such as UV diode lasers to produce the beam 120, a beam scanning mechanism to scan the beam 120 horizontally and vertically to render one image frame at a time on the screen 101, and a signal modulation mechanism to modulate the beam 120 to carry the information for image channels for red, green and blue colors. Such display systems may be configured as rear projection systems where the viewer and the laser module 110 are on the opposite sides of the screen 101. Alternatively, such display systems may be configured as front projection systems where the viewer and laser module 110 are on the same side of the screen 101.

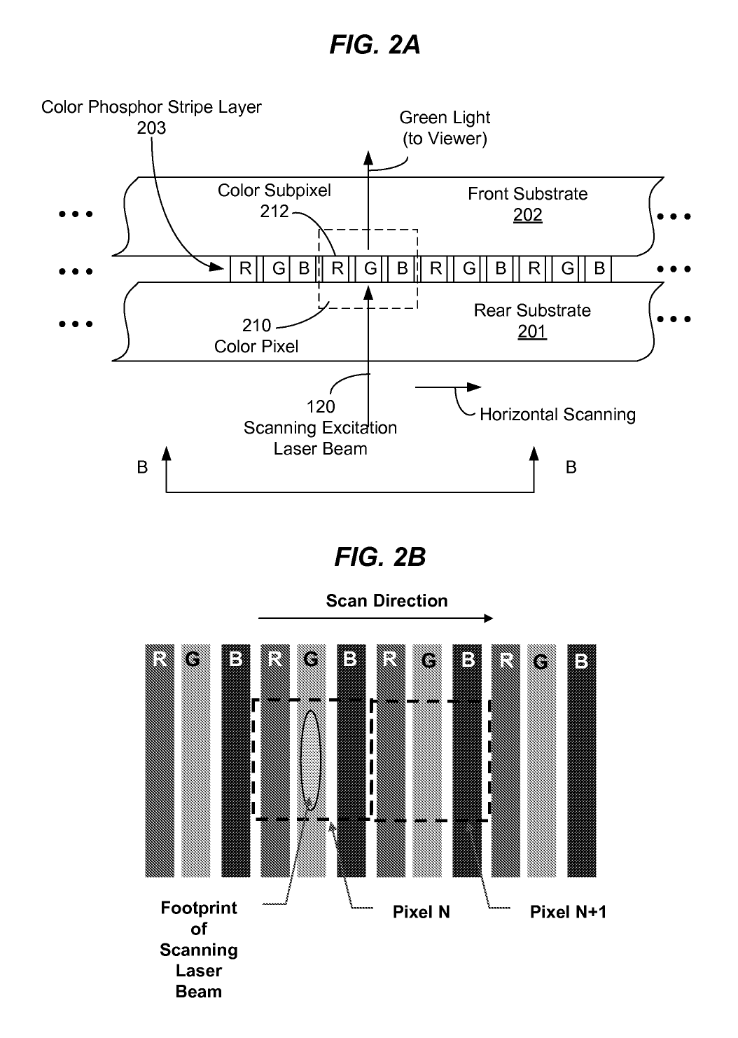

FIG. 2A shows an exemplary design of the screen 101 in FIG. 1. The screen 101 may include a rear substrate 201 which is transparent to the scanning laser beam 120 and faces the laser module 110 to receive the scanning laser beam 120. A second front substrate 202, is fixed relative to the rear substrate 201 and faces the viewer in a rear projection configuration. A color phosphor stripe layer 203 is placed between the substrates 201 and 202 and includes phosphor stripes. The color phosphor stripes for emitting red, green and blue colors are represented by “R”, “G” and “B,” respectively. The front substrate 202 is transparent to the red, green and blue colors emitted by the phosphor stripes. The substrates 201 and 202 may be made of various materials, including glass or plastic panels. Each color pixel includes portions of three adjacent color phosphor stripes in the horizontal direction and its vertical dimension is defined by the beam spread of the laser beam 120 in the vertical direction. As such, each color pixel includes three subpixels of three different colors (e.g., the red, green and blue). The laser module 110 scans the laser beam 120 one horizontal line at a time, e.g., from left to right and from top to bottom to fill the screen 101. The laser module 110 is fixed in position relative to the screen 101 so that the scanning of the beam 120 can be controlled in a predetermined manner to ensure proper alignment between the laser beam 120 and each pixel position on the screen 101.

In FIG. 2A, the scanning laser beam 120 is directed at the green phosphor stripe within a pixel to produce green light for that pixel. FIG. 2B further shows the operation of the screen 101 in a view along the direction B-B perpendicular to the surface of the screen 101. Since each color stripe is longitudinal in shape, the cross section of the beam 120 may be shaped to be elongated along the direction of the stripe to maximize the fill factor of the beam within each color stripe for a pixel. This may be achieved by using a beam shaping optical element in the laser module 110. A laser source that is used to produce a scanning laser beam that excites a phosphor material on the screen may be a single mode laser or a multimode laser. The laser may also be a single mode along the direction perpendicular to the elongated direction phosphor stripes to have a small beam spread that is confined by the width of each phosphor stripe. Along the elongated direction of the phosphor stripes, this laser beam may have multiple modes to spread over a larger area than the beam spread in the direction across the phosphor stripe. This use of a laser beam with a single mode in one direction to have a small beam footprint on the screen and multiple modes in the perpendicular direction to have a larger footprint on the screen allows the beam to be shaped to fit the elongated color subpixel on the screen and to provide sufficient laser power in the beam via the multimodes to ensure sufficient brightness of the screen.

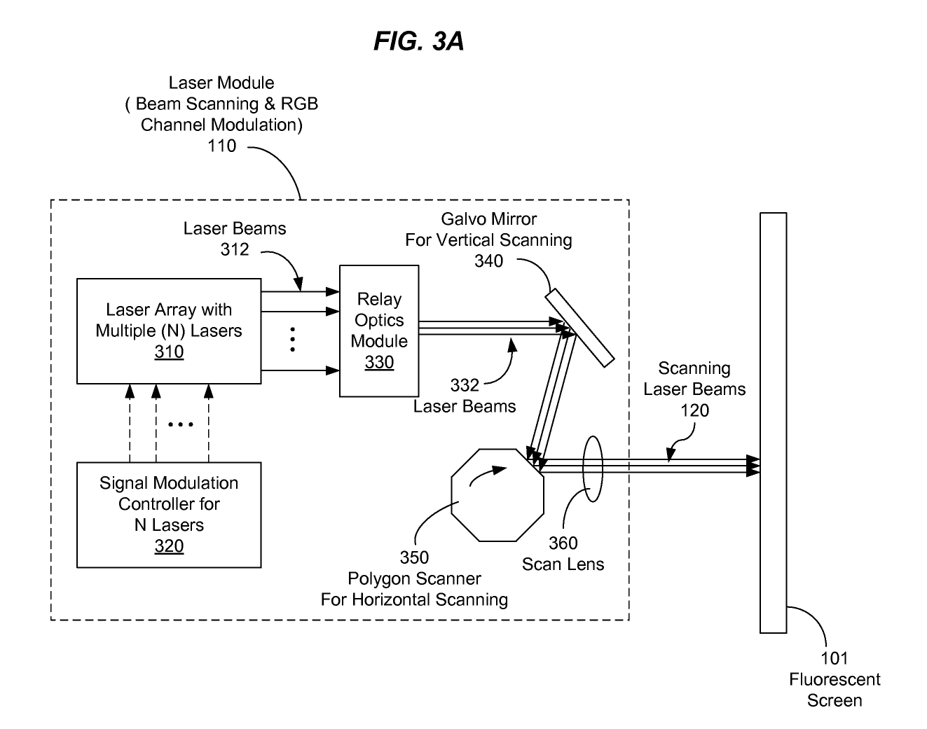

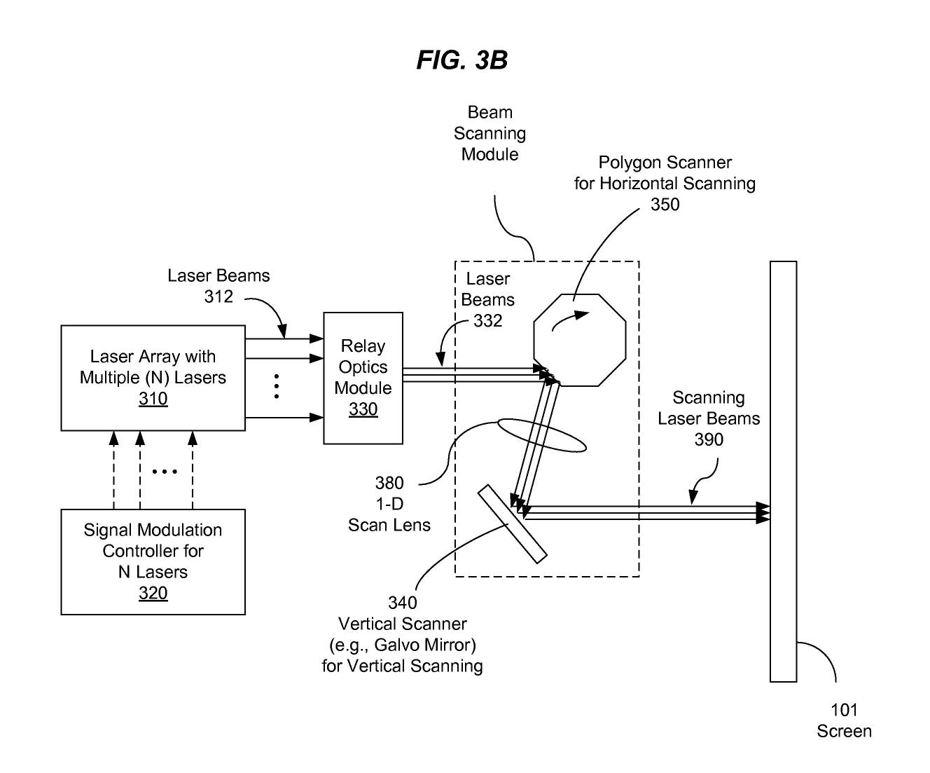

Referring now to FIG. 3A, an example implementation of the laser module 110 in FIG. 1 is illustrated. A laser array 310 with multiple lasers is used to generate multiple laser beams 312 to simultaneously scan the screen 101 for enhanced display brightness. A signal modulation controller 320 is provided to control and modulate the lasers in the laser array 310 so that the laser beams 312 are modulated to carry the image to be displayed on the screen 101. The signal modulation controller 320 can include a digital image processor that generates digital image signals for the three different color channels and laser driver circuits that produce laser control signals carrying the digital image signals. The laser control signals are then applied to modulate the lasers, e.g., the currents for laser diodes, in the laser array 310.

The beam scanning can be achieved by using a scanning mirror 340 such as a galvo mirror for the vertical scanning and a multi-facet polygon scanner 350 for the horizontal scanning. A scan lens 360 can be used to project the scanning beams form the polygon scanner 350 onto the screen 101. The scan lens 360 is designed to image each laser in the laser array 310 onto the screen 101. Each of the different reflective facets of the polygon scanner 350 simultaneously scans N horizontal lines where N is the number of lasers. In the illustrated example, the laser beams are first directed to the galvo mirror 340 and then from the galvo mirror 340 to the polygon scanner 350. The output scanning beams 120 are then projected onto the screen 101. A relay optics module 330 is placed in the optical path of the laser beams 312 to modify the spatial property of the laser beams 312 and to produce a closely packed bundle of beams 332 for scanning by the galvo mirror 340 and the polygon scanner 350 as the scanning beams 120 projected onto the screen 101 to excite the phosphors and to generate the images by colored light emitted by the phosphors.

The laser beams 120 are scanned spatially across the screen 101 to hit different color pixels at different times. Accordingly, each of the modulated beams 120 carries the image signals for the red, green and blue colors for each pixel at different times and for different pixels at different times. Hence, the beams 120 are coded with image information for different pixels at different times by the signal modulation controller 320. The beam scanning thus maps the time-domain coded image signals in the beams 120 onto the spatial pixels on the screen 101. For example, the modulated laser beams 120 can have each color pixel time equally divided into three sequential time slots for the three color subpixels for the three different color channels. The modulation of the beams 120 may use pulse modulation techniques to produce desired grey scales in each color, a proper color combination in each pixel, and desired image brightness.

In one implementation, the multiple beams 120 are directed onto the screen 101 at different and adjacent vertical positions with two adjacent beams being spaced from each other on the screen 101 by one horizontal line of the screen 101 along the vertical direction. For a given position of the galvo mirror 340 and a given position of the polygon scanner 350, the beams 120 may not be aligned with each other along the vertical direction on the screen 101 and may be at different positions on the screen 101 along the horizontal direction. The beams 120 can only cover one portion of the screen 101. At a fixed angular position of the galvo mirror 340, the spinning of the polygon scanner 350 causes the beams 120 from N lasers in the laser array 310 to scan one screen segment of N adjacent horizontal lines on the screen 101. At end of each horizontal scan over one screen segment, the galvo mirror 340 is adjusted to a different fixed angular position so that the vertical positions of all N beams 120 are adjusted to scan the next adjacent screen segment of N horizontal lines. This process iterates until the entire screen 101 is scanned to produce a full screen display.

In the above example of a scanning beam display system shown in FIG. 3A, the scan lens 360 is located downstream from the beam scanning devices 340 and 350 and focuses the one or more scanning excitation beams 120 onto the screen 101. This optical configuration is referred to as a “pre-objective” scanning system. In such a pre-objective design, a scanning beam directed into the scan lens 360 is scanned along two orthogonal directions. Therefore, the scan lens 360 is designed to focus the scanning beam onto the screen 101 along two orthogonal directions. In order to achieve the proper focusing in both orthogonal directions, the scan lens 360 can be complex and, often, are made of multiples lens elements. In one implementation, for example, the scan lens 360 can be a two-dimensional f-theta lens that is designed to have a linear relation between the location of the focal spot on the screen and the input scan angle (theta) when the input beam is scanned around each of two orthogonal axes perpendicular to the optic axis of the scan lens. In such a f-theta lens, the location of the focal spot on the screen is a proportional to the input scan angle (theta).

The two-dimensional scan lens 360 such as a f-theta lens in the pre-objective configuration can exhibit optical distortions along the two orthogonal scanning directions which cause beam positions on the screen 101 to trace a curved line. Hence, an intended straight horizontal scanning line on the screen 101 becomes a curved line. The distortions caused by the 2-dimensional scan lens 360 can be visible on the screen 101 and thus degrade the displayed image quality. One way to mitigate the bow distortion problem is to design the scan lens 360 with a complex lens configuration with multiple lens elements to reduce the bow distortions. The complex multiple lens elements can cause the final lens assembly to depart from desired f-theta conditions and thus can compromise the optical scanning performance. The number of lens elements in the assembly usually increases as the tolerance for the distortions decreases. However, such a scan lens with complex multiple lens elements can be expensive to fabricate.

To avoid the above distortion issues associated with a two-dimensional scan lens in a pre-objective scanning beam system, the following sections describe examples of a post-objective scanning beam display system, which can be implemented to replace the two-dimensional scan lens 360 with a simpler, less expensive 1-dimensional scan lens. U.S. patent application Ser. No. 11/742,014 entitled “POST-OBJECTIVE SCANNING BEAM SYSTEMS” and filed on Apr. 30, 2007 (U.S. Pat. No. ______) describes examples of post-objective scanning beam systems suitable for use with phosphor screens described in this application and is incorporated by reference as part of the specification of this application. The screen designs described in this application can be used in both post-objective and pre-objective scanning beam display systems.

FIG. 3B shows an example implementation of a post-objective scanning beam display system based on the system design in FIG. 1. A laser array 310 with multiple lasers is used to generate multiple laser beams 312 to simultaneously scan a screen 101 for enhanced display brightness. A signal modulation controller 320 is provided to control and modulate the lasers in the laser array 310 so that the laser beams 312 are modulated to carry the image to be displayed on the screen 101. The beam scanning is based on a two-scanner design with a horizontal scanner such as a polygon scanner 350 and a vertical scanner such as a galvanometer scanner 340. Each of the different reflective facets of the polygon scanner 350 simultaneously scans N horizontal lines where N is the number of lasers. A relay optics module 330 reduces the spacing of laser beams 312 to form a compact set of laser beams 332 that spread within the facet dimension of the polygon scanner 350 for the horizontal scanning. Downstream from the polygon scanner 350, there is a 1-D horizontal scan lens 380 followed by a vertical scanner 340 (e.g., a galvo mirror) that receives each horizontally scanned beam 332 from the polygon scanner 350 through the 1-D scan lens 380 and provides the vertical scan on each horizontally scanned beam 332 at the end of each horizontal scan prior to the next horizontal scan by the next facet of the polygon scanner 350. The vertical scanner 340 directs the 2-D scanning beams 390 to the screen 101.

Under this optical design of the horizontal and vertical scanning, the 1-D scan lens 380 is placed downstream from the polygon scanner 140 and upstream from the vertical scanner 340 to focus each horizontal scanned beam on the screen 101 and minimizes the horizontal bow distortion to displayed images on the screen 101 within an acceptable range, thus producing a visually “straight” horizontal scan line on the screen 101. Such a 1-D scan lens 380 capable of producing a straight horizontal scan line is relatively simpler and less expensive than a 2-D scan lens of similar performance. Downstream from the scan lens 380, the vertical scanner 340 is a flat reflector and simply reflects the beam to the screen 101 and scans vertically to place each horizontally scanned beam at different vertical positions on the screen 101 for scanning different horizontal lines. The dimension of the reflector on the vertical scanner 340 along the horizontal direction is sufficiently large to cover the spatial extent of each scanning beam coming from the polygon scanner 350 and the scan lens 380. The system in FIG. 3B is a post-objective design because the 1-D scan lens 380 is upstream from the vertical scanner 340. In this particular example, there is no lens or other focusing element downstream from the vertical scanner 340.

Notably, in the post-objective system in FIG. 3B, the distance from the scan lens to a location on the screen 101 for a particular beam varies with the vertical scanning position of the vertical scanner 340. Therefore, when the 1-D scan lens 380 is designed to have a fixed focal distance along the straight horizontal line across the center of the elongated 1-D scan lens, the focal properties of each beam must change with the vertical scanning position of the vertical scanner 380 to maintain consistent beam focusing on the screen 101. In this regard, a dynamic focusing mechanism can be implemented to adjust convergence of the beam going into the 1-D scan lens 380 based on the vertical scanning position of the vertical scanner 340.

For example, in the optical path of the one or more laser beams from the lasers to the polygon scanner 350, a stationary lens and a dynamic refocus lens can be used as the dynamic focusing mechanism. Each beam is focused by the dynamic focus lens at a location upstream from the stationary lens. When the focal point of the lens coincides with the focal point of the lens, the output light from the lens is collimated. Depending on the direction and amount of the deviation between the focal points of the lenses, the output light from the collimator lens toward the polygon scanner 350 can be either divergent or convergent. Hence, as the relative positions of the two lenses along their optic axis are adjusted, the focus of the scanned light on the screen 101 can be adjusted. A refocusing lens actuator can be used to adjust the relative position between the lenses in response to a control signal. In this particular example, the refocusing lens actuator is used to adjust the convergence of the beam directed into the 1-D scan lens 380 along the optical path from the polygon scanner 350 in synchronization with the vertical scanning of the vertical scanner 340. The vertical scanner 340 in FIG. 3B scans at a much smaller rate than the scan rate of the first horizontal scanner 350 and thus a focusing variation caused by the vertical scanning on the screen 101 varies with time at the slower vertical scanning rate. This allows a focusing adjustment mechanism to be implemented in the system of FIG. 1 with the lower limit of a response speed at the slower vertical scanning rate rather than the high horizontal scanning rate.

The stripe design in FIG. 2B for the fluorescent screen 101 in FIGS. 1, 3A and 3B can be implemented in various configurations. FIG. 2A shows one example which places the fluorescent layer 203 such as a color phosphor stripe layer between two substrates 201 and 202. In a rear projection system, it is desirable that the screen 101 couple as much light as possible in the incident scanning excitation beam 120 into the fluorescent layer with while maximizing the amount of the emitted light from the fluorescent layer that is directed towards the viewer side. A number of screen mechanisms can be implemented, either individually or in combination, in the screen 101 to enhance the screen performance, including efficient collection of the excitation light, maximization of fluorescent light directed towards the viewer side, enhancement of the screen contrast and reduction of the screen glare. The structure and materials of the screen 101 can be designed and selected to meet constraints on cost and other requirements for specific applications.

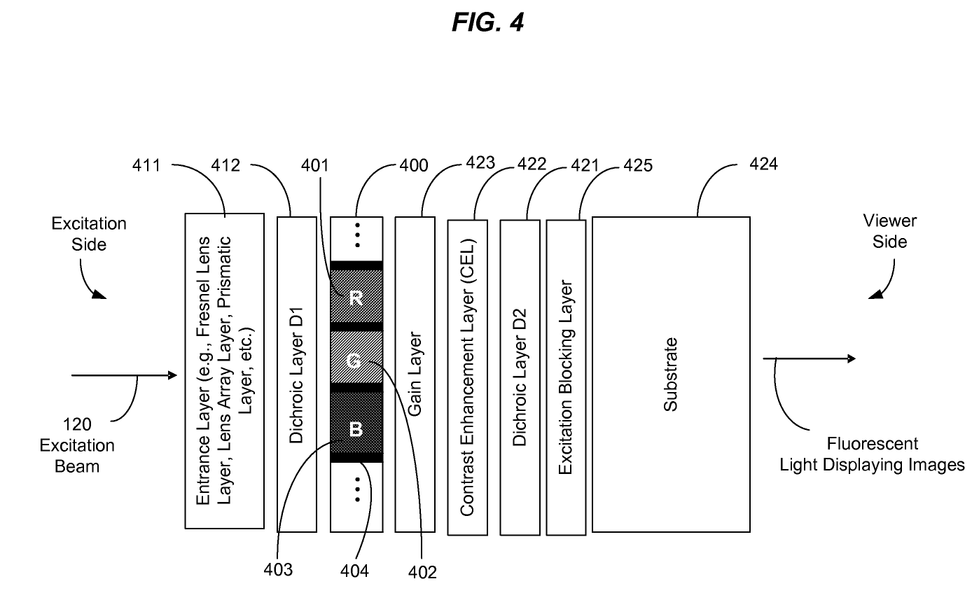

FIG. 4 illustrates an example screen 101 having a fluorescent stripe layer with fluorescent stripes for emitting red, green and blue colors under optical excitation of the scanning excitation light. A number of screen features are illustrated as examples and can be selectively implemented in specific screens. Hence, a particular fluorescent screen having only some of the features illustrated in FIG. 4 may be sufficient for a particular display application.

The fluorescent screen 101 in FIG. 4 includes at least one substrate layer 424 to provide a rigid structural support for various screen components including a fluorescent layer 400. This substrate layer 424 can be a thin substrate or a rigid sheet. When placed on the viewer side of the fluorescent layer 400 as illustrated in FIG. 4, the substrate layer 424 can be made of a material transparent or partially transparent to the visible colored light emitted by the fluorescent stripes 401, 402, 403. A partial transparent material can have a uniform attenuation to the visible light including the three colors emitted by the fluorescent stripes to operate like an optical neutral density filter. The substrate layer 424 can be made of a plastic material, a glass material, or other suitable dielectric material. For example, the substrate layer 424 may be made of an acrylic rigid sheet. The thickness of the substrate layer 424 may be a few millimeters in some designs. In addition, the substrate layer 424 may be made opaque and reflective to the excitation light of the excitation beam 120 to block the excitation light from reaching the viewer and to recycle the unabsorbed excitation light back to the fluorescent layer 400.

The substrate layer 424 can also be located on the other side of the fluorescent layer 400. Because the excitation beam 120 must transmit through the substrate layer 424 to enter the fluorescent layer 400, the material for the substrate layer 424 should be transparent to the excitation light of the excitation beam 120. In addition, the substrate layer 424 in this configuration may also be reflective to the visible light emitted by the fluorescent layer 400 to direct any emitted visible light coming from the fluorescent layer 400 towards the viewer side to improve the brightness of the displayed images.

The fluorescent layer 400 includes parallel fluorescent stripes with repetitive color patterns such as red, green and blue phosphor stripes. The fluorescent stripes are perpendicular to the horizontal scan direction of the scanning excitation beam 120 shown in FIG. 1. As illustrated in FIG. 4 and in FIG. 2B, each display pixel on the screen includes three subpixels which are portions of adjacent red, green and blue stripes 401, 402 and 402. The dimension of each subpixel along the horizontal direction is defined by the width of each stripe and the dimension along the vertical direction is defined by the beam width along the vertical direction. A stripe divider 404, which can be optically reflective and opaque, or optically absorbent, may be formed between any two adjacent fluorescent stripes to minimize or reduce the cross talk between two adjacent subpixels. As a result, the smearing at a boundary between two adjacent subpixels within one color pixel and between two adjacent color pixels can be reduced, and the resolution and contrast of the screen can be improved. The sidewalls of each stripe divider 404 can be made optically reflective to improve the brightness of each subpixel and the efficiency of the screen. In addition, the facets of the stripe dividers 404 facing the viewer side may be blackened, e.g., by being coated with a blackened absorptive layer, to reduce reflection or glare to the viewer side.

The above basic structure of the substrate layer 424 and the fluorescent layer 400 can be used as a building block to add one or more screen elements to enhance various properties and the performance of the screen. The fluorescent layer 400 is an optically active layer in the context that the excitation light at the excitation wavelength is absorbed by the fluorescent materials and is converted into visible fluorescent light of different colors for displaying the images to the viewer. In this regard, the fluorescent layer 400 is also the division between the “excitation side” and the “viewer side” of the screen where the optical properties of the two sides are designed very differently in order to achieve desired optical effects in each of two sides to enhance the screen performance. Examples of such optical effects include, enhancing coupling of the excitation beam 120 into the fluorescent layer, recycling reflected and scattered excitation light that is not absorbed by the fluorescent layer 400 back into the fluorescent layer 400, maximizing the amount of the emitted visible light from the fluorescent layer 400 towards the viewer side of the screen, reducing screen glare to the viewer caused by reflection of the ambient light, blocking the excitation light from existing the screen towards the viewer, and enhancing the contrast of the screen. Various screen elements can be configured to achieve one or more of these optical effects. Several examples of such screen elements are illustrated in FIG. 4.

Referring to FIG. 4, at the entry side of the screen facing the excitation beam 120, an entrance layer 411 can be provided to couple the excitation beam 120 into the screen 101. For example, a Fresnel lens layer can be used as this entrance layer 411 to control the incidence direction of the scanning excitation beam 120. For another example, a lens array layer having an array of lens elements and a matching pinhole array with multiple lenses in each subpixel or within a width of a fluorescent stripe may be implemented in this entrance layer 411. Such a lens layer can be used to replace the dichroic layer 412 (D1). For yet another example, a prismatic layer or a high-index dielectric layer can also be used as part of the entrance layer 411 to recycle light back into the screen including the excitation light and the emitted visible light by the fluorescent layer. To improve the brightness of the screen to the viewer, a first dichroic layer 412 (D1) may be placed in the path of the excitation beam 120 upstream from the fluorescent layer 400 (e.g., on the excitation side of the fluorescent layer 400) to transmit light at the wavelength of the excitation beam 120 and to reflect visible light emitted by the fluorescent layer 400. The first dichroic layer 412 can reduce the optical loss of the fluorescent light and thus enhances the screen brightness. On the viewer side of the fluorescent layer 400, a second dichroic layer 421 (D2) may be provided to transmit the visible light emitted by the fluorescent layer 400 and to reflect light at the wavelength of the excitation beam 120. Hence, the second dichroic layer 421 can recycle the excitation light that passes through the fluorescent layer 400 back to the fluorescent layer 400 and thus increases the utilization efficiency of the excitation light and the screen brightness.

On the viewer side of the fluorescent layer 400, a contrast enhancement layer 422 can be included to improve the screen contrast. The contrast enhancement layer 422 can include color-selective absorbing stripes that spatially correspond to and align with fluorescent stripes in the fluorescent layer 400 along the direction perpendicular to the screen layers. The color-selective absorbing stripes therefore transmit light in respective colors of the fluorescent stripes and absorb light in colors of other fluorescent stripes, respectively. Alternatively, the contrast enhancement layer 422 can be an optical neutral density filter layer that uniformly attenuates the visible light to reduce the glare of the screen due to the reflection of the ambient light. This neutral density filtering function may also be implemented in one or more other layers on the viewer side of the fluorescent layer 400, including the substrate layer 424.

In addition, the screen can include a screen gain layer 423 on the viewer side of the fluorescent layer 400 to optically enhance the brightness and viewing angle of the screen. The gain layer 423 may include a lenticular layer with lens elements, a diffractive optic layer of diffractive elements, a holographic layer with holographic elements, or a combination of these and other structures. The spatial sequence of the layers 423, 422 and 421 on the viewer side of the fluorescent layer 400 may be different from what is shown in FIG. 4.

Furthermore, an excitation blocking layer 425 can be placed on the viewer side of the fluorescent layer 400 to block any excitation light from exiting the screen to the viewer side. This layer can be implemented by a material that transmits the visible light and absorbs the excitation light. For example, a polyester based color filter can be used as this layer to block the excitation light which may be radiation from 400-415 nm. In some implementations, this blocking filter may have transmission below 410 nm less than 0.01%, while having greater than 50% transmission above 430 nm. The neutral density filtering function can also be incorporated in this layer, e.g., having a uniform attenuation to the visible light between 430 nm and 670 nm. This blocking function can be incorporated into the substrate layer 424.

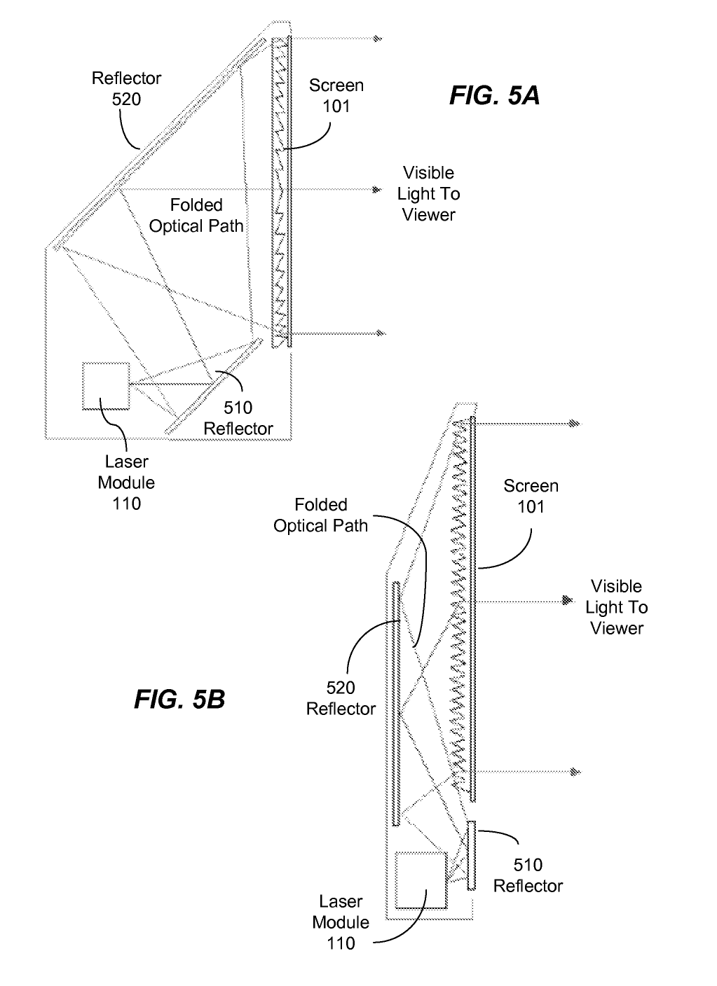

The above scanning beam display systems can be implemented using folded optical paths for directing scanning beams from the laser module 110 to the fluorescent screen 101 to reduce the physical spacing between the laser module 110 and the screen 101. FIGS. 5A and 5B show two folded optical designs that direct the output scanning laser beams from the laser module 110 to the fluorescent screen 101 in rear projection configurations. At least two reflectors 510 and 520 are used to direct the scanning beams along a folded optical path onto the screen 101. The reflectors 510 and 520 can be in various geometries and configurations. Such folded designs reduce the physical dimension of the scanning display systems. In one implementation, at least one of the reflectors 510 and 520 may have a curved surface to have a predetermined amount of optical power. For example, the optical power of the reflectors 510 and 520 can be selected in connection with the optical power of the scan lens 360 to reduce the optical path length from the scan lens 360 to the screen 101.

The laser beams 120 are scanned spatially across the screen 101 to hit different color pixels at different times. Accordingly, each of the modulated beams 120 carries the image signals for the red, green and blue colors for each pixel at different times and for different pixels at different times. Hence, the beams 120 are coded with image information for different pixels at different times by the signal modulation controller 520. The beam scanning thus maps the timely coded image signals in the beams 120 onto the spatial pixels on the screen 101.

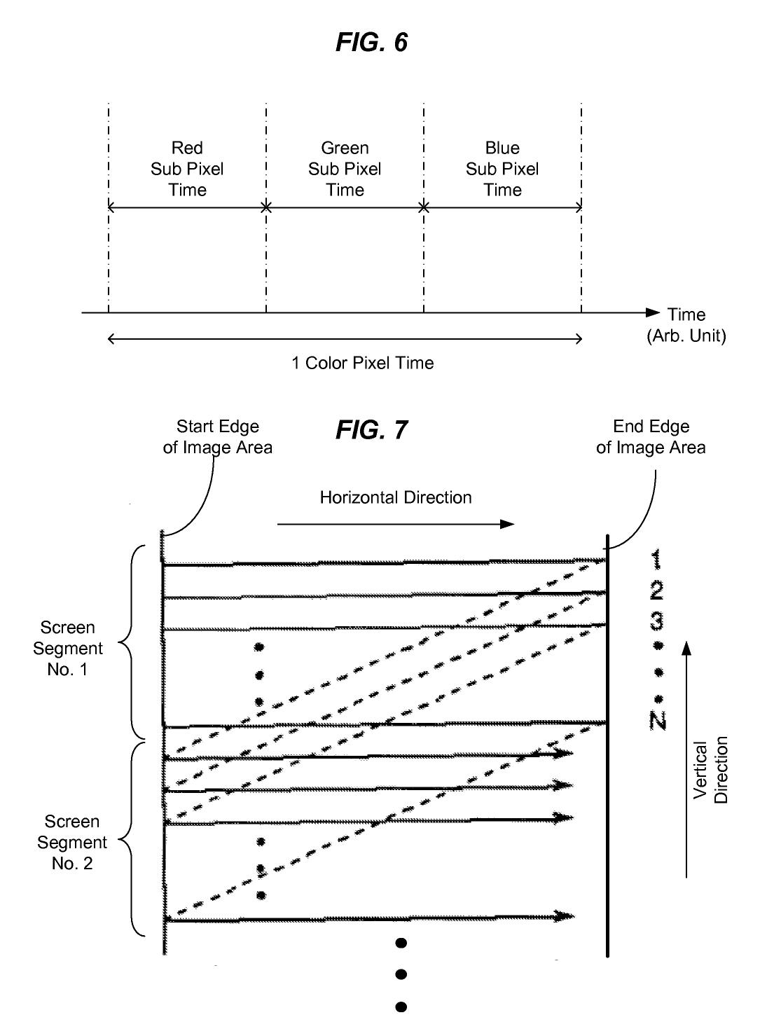

For example, FIG. 6 shows one example for time division on each modulated laser beam 120 where each color pixel time is equally divided into three sequential time slots for the three color channels. The modulation of the beam 120 may use pulse modulation techniques, such as pulse width modulation, pulse amplitude modulation or a combination of pulse width modulation and pulse amplitude modulation, to produce desired grey scales in each color, proper color combination in each pixel, and desired image brightness.

The beams 120 on the screen 101 are located at different and adjacent vertical positions with two adjacent beams being spaced from each other on the screen 101 by one horizontal line of the screen 101 along the vertical direction. For a given position of the galvo mirror 540 and a given position of the polygon scanner 550, the beams 120 may not be aligned with each other along the vertical direction on the screen 101 and may be at different positions on the screen 101 along the horizontal direction. The beams 120 can cover one portion of the screen 101. At a fixed angular position of the galvo mirror 540, the spinning of the polygon scanner 550 causes the beams 120 from N lasers in the laser array 510 to scan one screen segment of N adjacent horizontal lines on the screen 101. At the end of each horizontal scan, the galvo mirror 540 is adjusted to a different fixed angular position so that the vertical positions of all N beams 120 are adjusted to scan the next adjacent screen segment of N horizontal lines. This process iterates until the entire screen 101 is scanned to produce a full screen display.

FIG. 7 illustrates the above simultaneous scanning of one screen segment with multiple scanning laser beams 120 at a time. Visually, the beams 120 behaves like a paint brush to “paint” one thick horizontal stroke across the screen 101 at a time to cover one screen segment between the start edge and the end edge of the image area of the screen 101 and then subsequently to “paint” another thick horizontal stroke to cover an adjacent vertically shifted screen segment. Assuming the laser array 310 has 36 lasers, a 1080-line progressive scan of the screen 101 would require scanning 30 vertical screen segments for a full scan. Hence, this configuration in an effect divides the screen 101 along the vertical direction into multiple screen segments so that the N scanning beams scan one screen segment at a time with each scanning beam scanning only one line in the screen segment and different beams scanning different sequential lines in that screen segment. After one screen segment is scanned, the N scanning beams are moved at the same time to scan the next adjacent screen segment.

In the above design with multiple laser beams, each scanning laser beam 120 scans only a number of lines across the entire screen along the vertical direction that is equal to the number of screen segments. Hence, the polygon scanner 550 for the horizontal scanning can operate at slower speeds than scanning speeds required for a single beam design where the single beam scans every line of the entire screen. For a given number of total horizontal lines on the screen (e.g., 1080 lines in HDTV), the number of screen segments decreases as the number of the lasers increases. Hence, with 36 lasers, the galvo mirror and the polygon scanner scan 30 lines per frame while a total of 108 lines per frame are scanned when there are only 10 lasers. Therefore, the use of the multiple lasers can increase the image brightness which is approximately proportional to the number of lasers used, and, at the same time, can also advantageously reduce the response speeds of the scanning system.

A scanning display system described in this specification can be calibrated during the manufacture process so that the laser beam on-off timing and position of the laser beam relative to the fluorescent stripes in the screen 101 are known and are controlled within a permissible tolerance margin in order for the system to properly operate with specified image quality. However, the screen 101 and components in the laser module 101 of the system can change over time due to various factors, such as scanning device jitter, changes in temperature or humidity, changes in orientation of the system relative to gravity, settling due to vibration, aging and others. Such changes can affect the positioning of the laser source relative to the screen 101 over time and thus the factory-set alignment can be altered due to such changes. Notably, such changes can produce visible and, often undesirable, effects on the displayed images. For example, a laser pulse in the scanning excitation beam 120 may hit a subpixel that is adjacent to an intended target subpixel for that laser pulse due to a misalignment of the scanning beam 120 relative to the screen along the horizontal scanning direction. When this occurs, the coloring of the displayed image is changed from the intended coloring of the image. Hence, a red flag in the intended image may be displayed as a green flag on the screen. For another example, a laser pulse in the scanning excitation beam 120 may hit both the intended target subpixel and an adjacent subpixel next to the intended target subpixel due to a misalignment of the scanning beam 120 relative to the screen along the horizontal scanning direction. When this occurs, the coloring of the displayed image is changed from the intended coloring of the image and the image resolution deteriorates. The visible effects of these changes can increase as the screen display resolution increases because a smaller pixel means a smaller tolerance for a change in position. In addition, as the size of the screen increases, the effect of a change that can affect the alignment can be more pronounced because a large moment arm associated with a large screen means that an angular error can lead to a large position error on the screen. For example, if the laser beam position on the screen for a known beam angle changes over time, the result is a color shift in the image. This effect can be noticeable and thus undesirable to the viewer.

Implementations of various alignment mechanisms are provided in this specification to maintain proper alignment of the scanning beam 120 on the desired sub-pixel to achieved desired image quality. These alignment mechanisms include reference marks on the screen, both in the fluorescent area and in one or more peripheral area outside the fluorescent area, to provide feedback light that is caused by the excitation beam 120 and represents the position and other properties of the scanning beam on the screen. The feedback light can be measured by using one or more optical servo sensors to produce a feedback servo signal. A servo control in the laser module 110 processes this feedback servo signal to extract the information on the beam positioning and other properties of the beam on the screen and, in response, adjust the direction and other properties of the scanning beam 120 to ensure the proper operation of the display system.

For example, a feedback servo control system can be provided to use peripheral servo reference marks positioned outside the display area unobservable by the viewer to provide control over various beam properties, such as the horizontal positioning along the horizontal scanning direction perpendicular to the fluorescent stripes, the vertical positioning along the longitudinal direction of the fluorescent stripes, the beam focusing on the screen for control the image sharpness, and the beam power on the screen for control the image brightness. For another example, a screen calibration procedure can be performed at the startup of the display system to measure the beam position information as a calibration map so having the exact positions of sub-pixels on the screen in the time domain. This calibration map is then used by the laser module 110 to control the timing and positioning of the scanning beam 120 to achieve the desired color purity. For yet another example, a dynamic servo control system can be provided to regularly update the calibration map during the normal operation of the display system by using servo reference marks in the fluorescent area of the screen to provide the feedback light without affecting the viewing experience of a viewer.

The servo feedback implementations can use various optical detection of beam positioning on the screen. For example, two optical detection methods can be used to detect the location of a beam relative to a target feature on the screen, which may be a subpixel or a selected position on the screen such as the beginning edge of the fluorescent area. In the first optical detection method, the light impinging on a servo reference mark for the target feature can be guided as the feedback light through air or other medium to reach one or more respective optical servo sensing detectors which convert the optical light levels of the feedback light into electrical amplitude signals. The second optical detection method uses one or more optical servo sensing detectors placed in air to collect diffused light from a servo reference mark on the screen as the feedback light for the servo control. In detecting diffused light, an optical servo sensing detector can be placed behind a collection lens such as a hemispherical lens. Radiation detectors can be used to detect feedback light from diffusive type targets, e.g., targets that allow the light to diffuse in a wide angular spectrum. An example of a diffuse target is a rough surface such as a surface with a white paint. Both techniques can be used with reflective or transmissive servo reference marks.

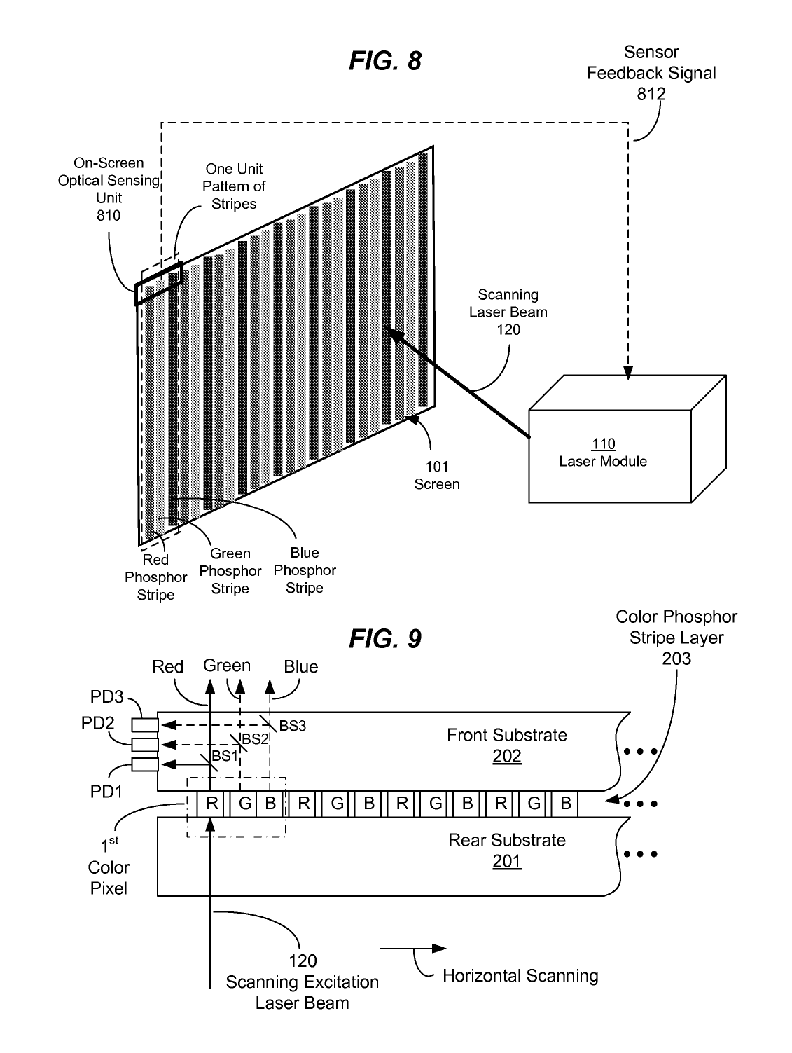

FIG. 8 shows an exemplary scanning beam display system with an on-screen optical sensing unit and a feedback control to allow the laser module 110 to correct the horizontal misalignment. The screen 101 includes an on-screen optical sensing unit 810 for optically measuring the responses of color subpixels on the screen 101 to produce a sensor feedback signal 812. The laser module 110 has a feedback control to allow the laser module 110 to correct the misalignment in response to the feedback signal 812 from the screen 101.

FIG. 9 shows one example of the on-screen optical sensing unit 810 which includes three optical “direct” detectors PD1, PD2 and PD3 that are respectively configured to respond to red, green and blue light. In this specific example, three beam splitters BS1, BS2 and BS3 are placed behind red, green and blue subpixels of a color pixel, respectively and are used to split small fractions of red, green, and blue light beams emitted from the color sub pixels of the color pixel to the three detectors PD1, PD2 and PD3 formed on the front substrate of the screen 101. Alternatively, the above red, green and blue optical detectors PD1, PD2 and PD3 may also be positioned on the screen 101 to allow each detector to receive light from multiple pixels on the screen 101. Each optical detector is only responsive to its designated color to produce a corresponding detector output and does not produce a detector output when receiving light of other colors. Hence, the red optical detector PD1 detects only the red light and is not responsive to green and blue light; the green optical detector PD 2 detects only green light and is not responsive to red and blue light; and the blue optical detector PD3 detects only the blue light and is not responsive to red and green light. This color selective response of the one-screen optical sensing unit 810 may be achieved by, e.g., using red, green and blue optical bandpass filters in front of the optical detectors PD1, PD2 and PD3, respectively, when each detector is exposed to light of different colors from the screen 101, or placing the optical detectors PD1, PD2 and PD3 in a way that only light of a designated color can enter a respective optical detector for the designated color. Assume the adjacent color phosphor stripes are arranged in the order of red, green and blue from the left to the right in the horizontal direction of the screen 101. Consider a situation where a red image is generated by the display processor in the laser module 110. When the horizontal alignment is out of order or misaligned by one sub pixel, the red detector does not respond while either the blue detector or the green detector produces an output. Such detector outputs can be processed by the feedback control in the laser module 110 to detect the horizontal misalignment and, accordingly, can adjust the timing of the optical pulses in the scanning beam to correct misalignment.

Alternative to the beam splitter in FIG. 9 a light guide or light pipe can be used. Light guides are structures that guide a portion of the light to an optical servo sensing detector. A light guide can be formed on the screen to direct feedback light via total internal reflection (TIR) in the light guide to the detector.

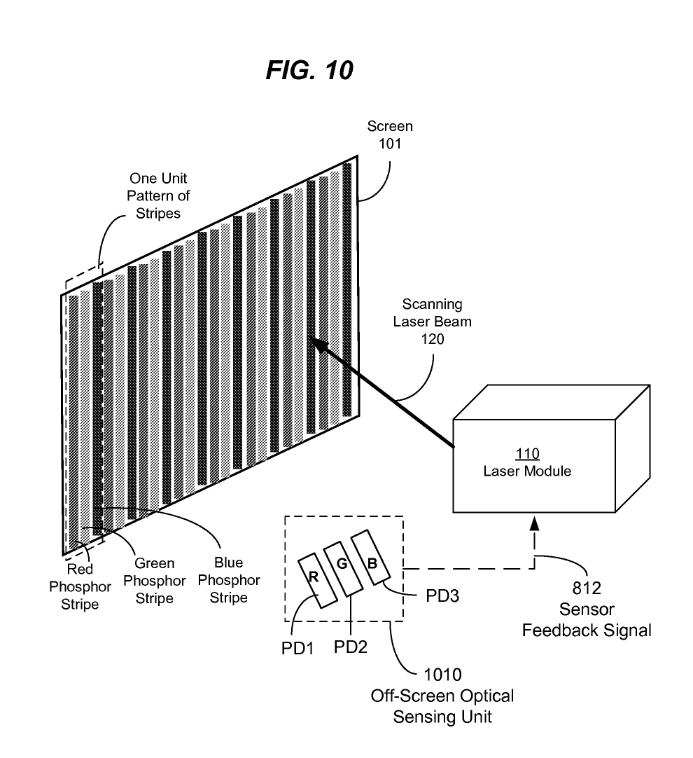

FIG. 10 shows another scanning beam display system with a servo feedback control using a radiation style detector. In this system, an off-screen optical sensing unit 1010 is used to detect the red, green and blue light emitted from the screen. Three optical detectors PD1, PD2 and PD3 are provided in the sensing unit 1010 to detect the red, green and blue fluorescent light, respectively. Each optical detector is designed to receive light from a part of or the entire screen. A bandpass optical filter can be placed in front of each optical detector to select a designated color while rejecting light of other colors.

One technical challenge in the scanning beam display systems in this application is the unintended spatial variation of the power of emitted light towards the viewer. When the intended image is a uniform blank image, e.g., a blue screen, the unintended spatial variation would cause the actually displayed blue screen to show a spatial variation in the brightness at different locations on the screen. This can be caused by various components in the optical path from the light source to the output surface of the screen.

Referring to FIG. 4, the optical transmission of some multilayer films for the dichroic layers 412 (D1) and 421 (D2) may not be spatially uniform and may vary from one position to another position on the film. In addition, the optical transmission of such a film can also vary with the wavelength of the incident light. Consider a multilayer film dichroic layer 412 (D1) which is designed to transmit excitation light 120 and reflect visible light.

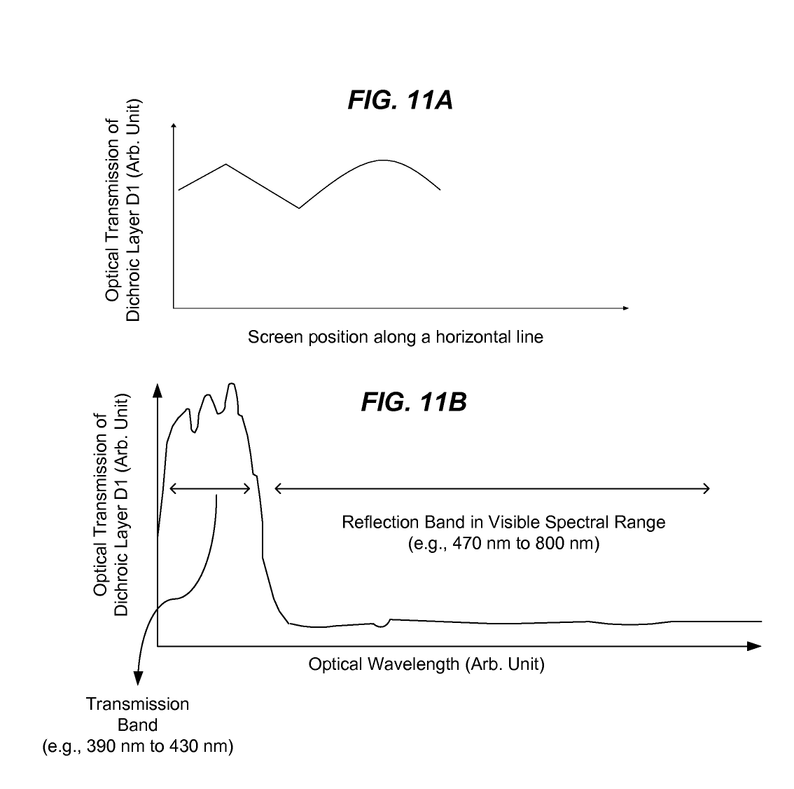

FIG. 11A shows an example of the optical transmission of a dichroic layer 412 (D1) at a given excitation wavelength as a function of the beam position on the film along one horizontal line. This spatial variation in optical transmission is undesirable because it causes uniform brightness in the displayed image. FIG. 11B further shows an example spectrum of a dichroic layer 412 (D1) where the optical transmission in the transmission band varies with wavelength. Therefore, when the laser wavelength of the laser that produces the excitation beam 120 changes, the brightness of the screen changes.

Other screen layers in FIG. 4 can also contribute to the undesired spatial variation in the output optical power of the screen 101. For example, the entrance layer 411 can include a lens array layer having an array of lens elements and a matching pinhole array with multiple lenses in each subpixel or within a width of a fluorescent stripe. Spatial variation in either or both of the lens array and the matching pinhole array can contribute to the spatial variation in the screen brightness. The optical incidence of the scanning beam 120 to the lens array layer can also contribute to additional spatial variation in the screen brightness.

As yet another example, referring to FIGS. 3A and 3B, spatially varying defects of optical components between the light source such as the layer array 310 and the screen 101 can also contribute to undesired spatial variation in the output optical power of the screen 101. For example, the optical design and manufacturing may cause certain spatially varying defects in lenses and reflective surfaces. In addition, undesired spatial variations in the reflectivity of each reflector in the folded optical path design in either FIG. 5A or FIG. 5B can also contribute to the unintended spatial variation of the power of emitted light towards the viewer.

The effects on the screen brightness caused by these and other untended variations in a scanning display system can be measured. The effect of the spatial variation of the optical transmission of the dichroic layer 412 (D1) on the final image, for example, can be measured by measuring the optical output of each pixel of the screen 101 for image data for a uniform image. An optical detector can be used to measure the optical output from each pixel on the viewer side. Such measurement can capture spatial variation of the screen 101 caused by the dichroic layer 412 (D1) and other contributing factors in the screen 101 and in the optical system.

Based on the measured data on the untended spatial variation in the screen brightness to the viewer, the laser power of the excitation beam 120 or each of multiple excitation beams 120 can be adjusted according to the beam position on the screen to reduce the untended spatial variation in the screen brightness. Hence, if the pixel output at a pixel position (x1, y1) on the screen 101 is lower than a desired output level, the power of the scanning beam 120 is set to be at a high power level when the beam 120 is directed to the pixel position (x1, y1); if the pixel output at a pixel position (x2, y2) on the screen 101 is higher than a desired output level, the power of the scanning beam 120 is set to be at a low power level when the beam 120 is directed to the pixel position (x2, y2) such that the pixel outputs at the two pixel positions (x1, y1) and (x2, y2) appear to be approximately the same to the viewer.

The power of the scanning excitation beam 120 can be adjusted with the beam position on the screen as the beam 120 scans from one screen position to another based on a spatial variation in pixel brightness of the screen to negate the spatial variation in pixel brightness that is caused by one or more factors, such as optical imperfections of the system in the screen including but not limited to film uniformity, non-uniformity in the fluorescent material, optical elements non uniformities in making lenses and mirrors. For example, an optical component in the path of the excitation beam 120 between the light source and the fluorescent layer of the screen may cause the spatial variation in the pixel brightness and this can be corrected using the present method.

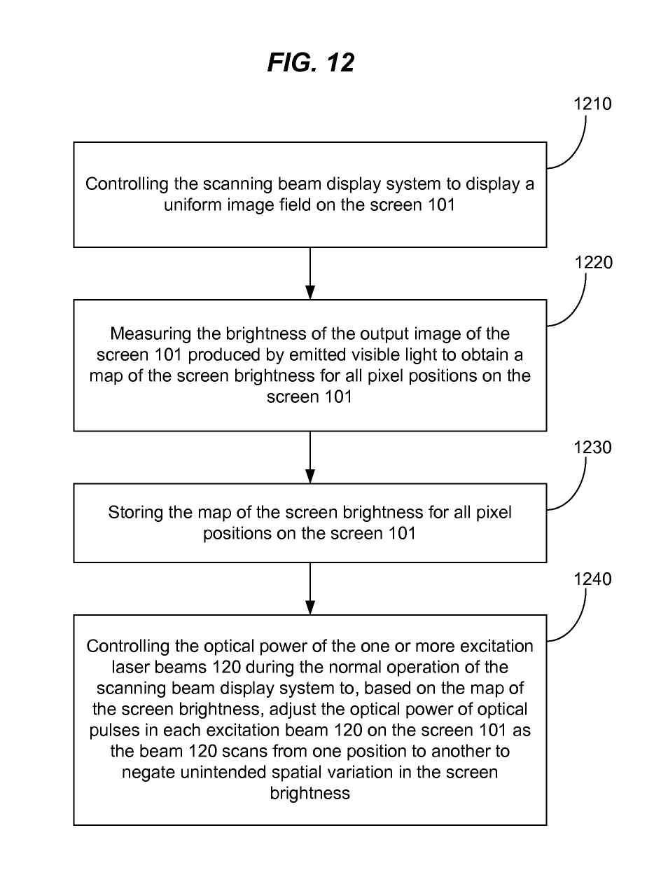

FIG. 12 shows an example of a calibration process of for obtaining a pixel-by-pixel map of the screen brightness and an example of using the map to control the system in the normal operation. In the calibration process, the scanning beam display system is controlled to display a test image pattern on the screen 101, e.g., a uniform image field (step 1210). The brightness of the output image of the screen 101 produced by emitted visible light is then measured at each pixel location on the screen 101 to obtain a map of the screen brightness for all pixel positions on the screen 101 (step 1220). This completes the calibration process which can be done at the factory. The measured map of the screen brightness for all pixel positions on the screen 101 is stored in a memory in the display system (step 1230). The display system is shipped to a user with the calibration map and automatically controls the system operation based on this map. During the normal operation, the controller of the display system accesses the data of the map of the screen brightness stored in the memory and controls the optical power of the one or more excitation laser beams 120 to, based on the map of the screen brightness, adjust the optical power of optical pulses in each excitation beam 120 on the screen 101 as the beam 120 scans from one position to another to negate unintended spatial variation in the screen brightness (step 1240). This control of the laser pulse power of the scanning beam 120 improves the display quality.

While this specification contains many specifics, these should not be construed as limitations on the scope of an invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or a variation of a subcombination.

Only a few implementations are disclosed. However, it is understood that variations and enhancements may be made.

What is claimed is:

1. A method for controlling a scanning beam display system, comprising:
scanning a beam of excitation light modulated with optical pulses on a screen with a fluorescent layer to excite the fluorescent layer to emit visible fluorescent light which forms images; and
adjusting optical power of the optical pulses in the beam of excitation light as the beam of excitation light moves from one screen position to another based on a spatial variation in pixel brightness of the screen to negate the spatial variation in pixel brightness of the screen.

2. The method as in claim 1, wherein:
the screen comprises a multilayer film layer that transmits the excitation light and reflects the visible fluorescent light emitted by the fluorescent layer and the optical transmission of the multilayer film layer varies with position of light on the multilayer film layer, and
the optical power of the optical pulses in the beam of excitation light is adjusted to negate spatial variation in optical transmission of the multilayer film layer.

3. The method as in claim 1, wherein:
the fluorescent layer in the screen has a spatial variation, and
the optical power of the optical pulses in the beam of excitation light is adjusted to negate the spatial variation of the fluorescent layer.

4. The method as in claim 1, wherein:
an optical component in an optical path of the beam of excitation light causes a spatial variation in the beam of excitation light in scanning through different locations on the screen, and
the optical power of the optical pulses in the beam of excitation light is adjusted to negate the spatial variation of the optical component.

5. The method as in claim 1, comprising:
obtaining a map of pixel brightness for the screen; and
controlling the optical power of the optical pulses in the beam of excitation light based on the map to negate the spatial variation in pixel brightness of the screen.

6. The method as in claim 5, wherein:
the map of pixel brightness for the screen is obtained in a calibration process which includes:
controlling the beam of excitation light to carry a test image pattern in a process of calibrating the scanning beam display system; and
measuring brightness of each pixel of the screen when the test image pattern is displayed to collect measured pixel brightness of the screen.

7. A scanning beam display system, comprising:
an optical module operable to produce a beam of excitation light having optical pulses that can carry image information;
a beam scanning module to scan the beam of excitation light along a first direction and a second, perpendicular direction;
a screen comprising a light-emitting area having a plurality of parallel light-emitting stripes each along the first direction and spatially displaced from one another along the second direction, wherein light-emitting stripes absorb the excitation light and emit visible light to produce images carried by the scanning beam of excitation light; and
a control unit operable to adjust optical power of the optical pulses in the beam of excitation light as the beam of excitation light moves from one screen position to another based on a spatial variation in pixel brightness of the screen to negate the spatial variation in pixel brightness of the screen.

8. The system as in claim 7, wherein:
the beam scanning module comprises:
a first beam scanner to scan the beam of excitation light along the first direction;
a second beam scanner to scan the beam of excitation light received from the first beam scanner along the second direction; and
a scan lens placed in an optical path of the beam of light between the first and the second beam scanners to direct the beam of excitation light from the first beam scanner along a line on the second beam scanner and to focus the beam of excitation light onto the screen.

9. The system as in claim 8, wherein:
the first beam scanner scans at a first scanning rate higher than a second scanning rate of the second beam scanner.

10. The system as in claim 9, wherein:
the first beam scanner is a polygon scanner comprising a plurality of different reflective facets, and
the second beam scanner is a 1-dimensional beam scanner.

11. The system as in claim 8, comprising:
two optical reflectors located in a folded optical path between the second beam scanner and the screen to direct the beam of excitation light onto the screen.

12. The system as in claim 7, wherein:
the beam scanning module comprises:
a first beam scanner to scan the beam of excitation light along the first direction;
a second beam scanner to scan the beam of excitation light received from the first beam scanner along the second direction; and
a scan lens placed in an optical path of the beam of light downstream from the second beam scanner to direct and focus the beam of excitation light from the second beam scanner onto the screen.

13. The system as in claim 12, comprising:
two optical reflectors located in a folded optical path between the scan lens and the screen to direct the beam of excitation light from the scan lens onto the screen.

14. A method for controlling a scanning beam display system, comprising:
scanning a beam of excitation light modulated with optical pulses on a screen with parallel light-emitting stripes in a beam scanning direction perpendicular to the light-emitting stripes to excite the fluorescent strips to emit visible light-emitting light which forms images;
modulating the beam of excitation light to carry a test image pattern which is displayed on the screen for calibrating the scanning beam display system;
measuring brightness of each pixel of the screen when the test image pattern is displayed to collect measured pixel brightness of the screen to represent spatial variation in pixel brightness of the screen; and
storing the measured pixel brightness of the screen for adjusting optical power of the optical pulses in the beam of excitation light, during a normal display of images on the screen, as the beam of excitation light moves from one screen position to another to negate the spatial variation in pixel brightness of the screen.
